(19) United States
(12) Patent Application Publication
(10) Pub. No.: US 2005/0216928 A1
(43) Pub. Date: Sep. 29, 2005

(54) Guide shaft holding mechanism and disk device with guide shaft holding mechanism

(75) Inventors: Hirotoshi Hara, Takefu-city (JP); Yuichi Kobayashi, Takefu-city (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: ORION ELECTRIC CO., LTD., Takefu-city (JP)

(21) Appl. No.: 11/085,191

(22) Filed: Mar. 22, 2005

(30) Foreign Application Priority Data
Mar. 25, 2004 (JP) 2004-088724

(51) Int. Cl. G11B 7/08

(52) U.S. Cl. 720/677

(57) ABSTRACT

The present invention aims at providing a guide shaft holding mechanism and disk device with guide shaft holding mechanism which allow, when a guide shaft is fixed using a hook, the guide shaft to be stably guided between guide walls which regulate the movement of the guide shaft in a radial direction. A holding member 5 which holds an end of a guide shaft 4 includes a base 7, a pair of right and left guide walls 8A, 8B disposed upright on both sides of the base 7 facing each other, a stopper section 9 having flexibility disposed upright at a back end of the base 7 and a hooking section 10 provided at one end of the stopper section 9. One guide wall 8A is formed to be higher than the stopper section 9 and can push the outer surface of the guide shaft 4 against the guide wall 8A before the guide shaft 4 is engaged with the hooking section 10. This allows the guide shaft 4 to be stably guided between the guide walls 8A, 8B with the guide shaft 4 being guided along the guide wall 8A.

The present application is based on and claims priority of Japanese patent application No. 2004-088724 filed on Mar. 25, 2004, the entire contents of which are hereby incorporated by reference.

### BACKGROUND OF THE INVENTION

1. Field of the Invention

The present invention relates to a guide shaft holding mechanism, and more particularly, to a guide shaft holding mechanism for translating a pickup which stores information in a storage medium such as an optical disk and reproduces information from the storage medium, and a disk device provided with the guide shaft holding mechanism.

2. Description of the Related Art

A disk device is provided with, for example, a pickup and this pickup translates along a pair of guide shafts fixed to a chassis in the radius direction of an optical disk to reproduce information stored in a storage medium such as an optical disk or store information in the storage medium. As such a technology for fixing the guide shafts for the pickup to the chassis, various structures have been conventionally proposed. For example, Japanese Utility Model Laid-Open Publication No. H02-046967 (Patent Document 1) discloses a technology of forming a reference piece and a pressing piece by bending those pieces from a chassis and twisting the pressing piece with an end of each of the guide shafts contacting the reference piece to hold both ends of the guide shaft, and Japanese Patent Laid-Open Publication No. H07-057404 (Patent Document 2) discloses a technology of providing a flange on a chassis, letting the outer surface of a guide shaft contact this flange and fixing a screw for pressing the guide shaft against the flange to hold the guide shaft with this screw and the flange.

However, the method of fixing the guide shafts by twisting the pressing piece formed integral with the chassis as described in the Patent Document 1 involves complicated work of positioning the guide shafts relative to the reference piece and further bending the pressing piece, which not only leads to poor working efficiency but also involves extreme difficulty in disassembling the guide shafts after the guide shafts are assembled. In this respect, according to the method of fixing the guide shafts using a screw as described in the Patent Document 2, it is relatively easy to disassemble the guide shafts by removing the screw, however, it is necessary to tighten or loosen the screw when attaching or detaching the guide shafts, which results in poor operability, increases the number of assembly parts and also involves screw-tightening work, and therefore it is inefficient also from the standpoint of work.

Thus, as a method capable of attaching/detaching the guide shafts through a one-touch simple operation without increasing the number of parts, it is possible to fix the guide shafts using an elastically deformable hook, for example. As a structure for fixing the guide shafts using a hook, as shown in FIG. 7, for example, a holding member H made of synthetic resin and the like for holding a guide shaft S is provided, and a pair of regulating sections H1 and a stopper section H2 having flexibility are formed in this holding member H and a hooking section H3 is formed at one end of this stopper section H2 as a single piece. Then, as shown with a two-dot dashed line in FIG. 7, by pushing one end of the guide shaft S against the hooking section H3 and pushing it in between the regulating sections H1, the stopper section H2 is restored elastically when the guide shaft S climbs over the hooking section H3. This causes the pair of regulating sections Hi to regulate the movement of the guide shaft S in the radial direction, causes the stopper section H2 to regulate the movement in the thrust direction and further allows the hooking section H3 and holding member H to regulate the movement in the vertical direction of the guide shaft S.

Thus, the structure in which the guide shaft S is held by the hooking section H3 allows the guide shaft S to be fixed to the holding member H through a one-touch simple operation of pushing in the guide shaft S between the regulating sections H1, making it possible to assemble the guide shaft S extremely simply without increasing the number of parts. However, according to the fixing method using such a hooking section H3, the guide shaft S which climbs over the hooking section H3 is inserted between the regulating sections H1 and the movement of the guide shaft S in the vertical direction inserted between the regulating sections H1 is regulated by the hooking section H3, and therefore the regulating sections H1 are positioned at the bottom of the hooking section H3 and there is no member for holding the guide shaft S when the hooking section H3 is engaged with the guide shaft S. On the other hand, when the hooking section H3 is engaged with the guide shaft S, the stopper section H2 is bent outward and a thrust due to the elastic restoring force is applied to the guide shaft S, and therefore as shown with a single-dot dashed line in FIG. 7, the guide shaft S is likely to fluctuate right and left and come off the hooking section H3, unable to guide the guide shaft S stably between the right and left regulating sections H1 and unable to perform efficient assembly work.

### SUMMARY OF THE INVENTION

The present invention has been implemented in view of the above described problems and it aims at providing a guide shaft holding mechanism and a disk device provided with the guide shaft holding mechanism capable of simply and easily fixing the guide shaft using a hook and stably guiding the guide shaft into a regulating member which regulates the movement thereof in a radial direction.

The guide shaft holding mechanism according to a first aspect of the present invention comprises a pair of holding members provided on a chassis, at least one of the holding members including a supporting section which supports the guide shaft, a pair of guide walls which regulate the movement of the guide shaft in a radial direction, a stopper section having flexibility which regulates the movement of the guide shaft in a thrust direction, and a hooking section which is formed in this stopper section, in which the guide shaft is engaged with the hooking section when the guide shaft is inserted between the guide walls and the hooking section and the supporting section regulates the movement of the guide shaft in the vertical direction, wherein at least one guide wall is formed to be higher than the hooking section so that the guide shaft and the guide wall can contact each other when the guide shaft is engaged with the hooking section.

According to the arrangement of the first aspect of the invention, an end of the guide shaft is brought into contact with the hooking section of the stopper section and pushed in between the stopper section and the guide wall. When this guide shaft is engaged with the hooking section, since the guide wall is formed to be higher than the hooking section, it is possible to move the guide shaft downward to bring an outer edge of the guide shaft into contact with the hooking section with the outer surface of the guide shaft pushed against the guide wall before the guide shaft is engaged with the hooking section of the stopper section. Thus, since the guide shaft can be engaged with the hooking section with the guide wall stably guiding the guide shaft, it is possible to suppress fluctuations of the guide shaft in the engagement between the guide shaft and the hooking section. Then, by further pushing in the guide shaft toward the guide wall with the guide shaft engaged with the hooking section, the hooking section is pushed and the stopper section is bent outward and when the guide shaft climbs over the hooking section, the stopper section is restored elastically. This regulates the movement in the radial direction of the guide shaft which is sandwiched between the right and the left guide walls and the restored hooking section and the supporting section regulate the movement of the guide shaft in the vertical direction.

The guide shaft holding mechanism according to a second aspect of the invention is the guide shaft holding mechanism according to the first aspect of the invention, wherein the hooking section has a tapered inclined plane capable of contacting an end face of the guide shaft and at least one guide wall is formed to be higher than the bottom end of this inclined plane.

According to the arrangement of the second aspect of the invention, the guide shaft is supported by the guide wall at the bottom end of the hooking section where the thrust of the hooking section is applied most strongly to the guide shaft.

The guide shaft holding mechanism according to a third aspect of the invention is the guide shaft holding mechanism according to the first or the second aspect of the invention, wherein when the guide shaft is engaged with the hooking section, at least one guide wall is set to be higher than contacts on the circumference of the circle of the guide shaft whose central angle is 120 degrees at least in the direction in which the guide shaft is inserted, or preferably set to be higher than contacts on the circumference of the circle of the guide shaft whose central angle is 180 degrees.

According to the arrangement of the third aspect of the invention, if at least one guide wall is formed to be higher than a contact on the circumference of the circle of the guide shaft whose central angle is 120 degrees, approximately ⅓ of the lower part of the guide shaft is hooked on the guide wall, and therefore the guide wall can suppress fluctuations of the guide shaft in the lateral direction. Furthermore, to suppress the deviation of the guide shaft more reliably, when the guide shaft is engaged with the hooking section, it is desirable to set the height of the guide wall to the diameter of the guide shaft when the guide shaft becomes thickest, that is, it is desirable to set the height of the guide wall to the same height of the contact on the circumference of the circle of the guide shaft whose central angle is 180 degrees, and setting it to the same height as that of the contact on the circumference of the circle of the guide shaft whose central angle is 180 degrees in this way makes it possible to suppress the deviation of the guide shaft more reliably.

The disk device with a guide shaft holding mechanism according to a fourth aspect of the invention is the disk device provided with the guide shaft holding mechanism according to the first or the second aspect of the invention, comprising a pickup which stores information in a storage medium or reproduces information from the storage medium, wherein the pickup is guided so as to translate through the guide shafts.

According to the arrangement according to the fourth aspect of the invention, the guide shaft is set in the chassis, the pickup translates along the guide shaft in the radius direction of the storage medium and stores information in the storage medium or reproduces information from the storage medium.

The guide shaft holding mechanism according to the first aspect of the present invention is a guide shaft holding mechanism comprising a pair of holding members provided on a chassis, at least one of the holding members including a supporting section which supports the guide shaft, a pair of guide walls which regulate the movement of the guide shaft in a radial direction, a stopper section having flexibility which regulates the movement of the guide shaft in a thrust direction, and a hooking section which is formed in the stopper section, in which the guide shaft is engaged with the hooking section when the guide shaft is inserted between the guide walls and the hooking section and the supporting section regulates the movement of the guide shaft in the vertical direction, wherein at least one guide wall is formed to be higher than the hooking section so that the guide shaft and the guide wall can contact each other when the guide shaft is engaged with the hooking section, and therefore it is possible to push the outer surface of the guide shaft against the guide wall before the guide shaft is engaged with the hooking section and stably guide the guide shaft between the guide walls with the guide shaft guided along the guide walls.

The guide shaft holding mechanism according to the second aspect of the invention is the guide shaft holding mechanism according to the first aspect of the invention, wherein the hooking section has a tapered inclined plane capable of contacting an end face of the guide shaft and at least one guide wall is formed to be higher than the bottom end of the inclined plane, and therefore the guide shaft can be stably supported by the guide wall at the bottom end of the hooking section where the thrust of the hooking section is applied to the guide shaft most strongly.

The guide shaft holding mechanism according to the third aspect of the invention is the guide shaft holding mechanism according to the first or the second aspect of the invention, wherein when the guide shaft is engaged with the hooking section, at least one guide wall is set to be higher than contacts on the circumference of the circle of the guide shaft whose central angle is 120 degrees at least in the direction in which the guide shaft is inserted, or preferably set to be higher than contacts on the circumference of the circle of the guide shaft whose central angle is 180 degrees, and therefore it is possible to keep the minimum necessary height of the guide wall and stably support the guide shaft by the guide wall.

The disk device with a guide shaft holding mechanism according to the fourth aspect of the invention is the disk device provided with the guide shaft holding mechanism according to the first or the second aspect of the invention, comprising a pickup which stores information in a storage medium or reproduces information from the storage medium, wherein the pickup is guided so as to translate through the guide shafts, and therefore it is possible to simply and easily fix the guide shaft that guides the pickup to the disk device with the pickup.

### BRIEF DESCRIPTION OF THE DRAWINGS

FIG. 1 is a perspective view of the vicinity of a holding member showing an embodiment of the present invention;

FIG. 2 is a plan view of a chassis of an embodiment of the present invention;

FIG. 3 shows a guide shaft in the process of assembly of an embodiment of the present invention in which FIG. 3A is a cross-sectional view thereof viewed from the lateral direction and FIG. 3B is a cross-sectional view thereof viewed from the front direction;

FIG. 4 shows the guide shaft already assembled of an embodiment of the present invention in which FIG. 4A is a cross-sectional view thereof viewed from the lateral direction and FIG. 4B is a cross-sectional view thereof viewed from the front direction;

FIG. 5 illustrates the height of the guide wall relative to the guide shaft of an embodiment of the present invention;

FIG. 6 is a cross-sectional view illustrating a modification example with both guide walls formed high of an embodiment of the present invention; and

FIG. 7 is a cross-sectional view showing an example where a guide shaft is fixed using a conventional hooking structure.

### DETAILED DESCRIPTION OF THE PREFERRED EMBODIMENTS

With reference now to the attached drawings, one preferred embodiment for implementing the present invention will be explained below.

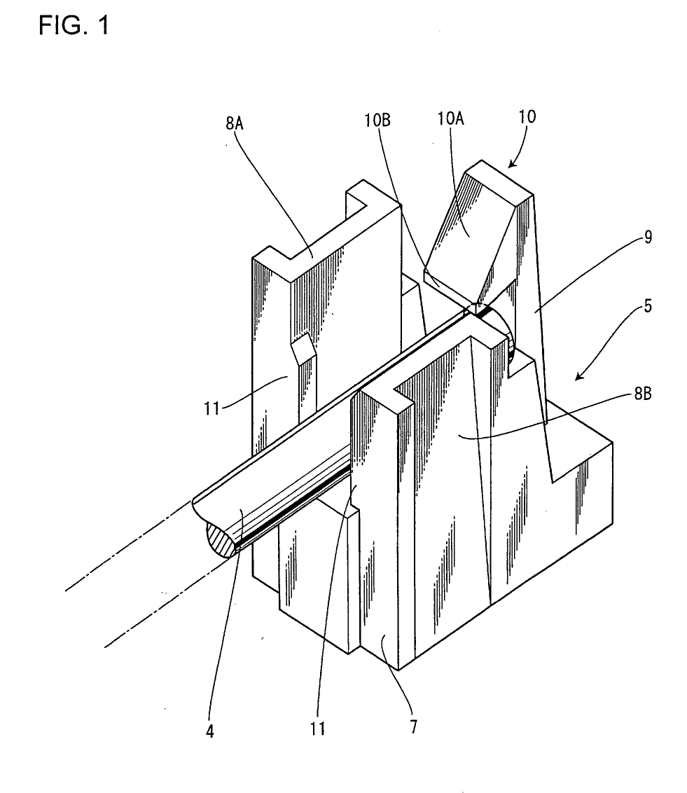

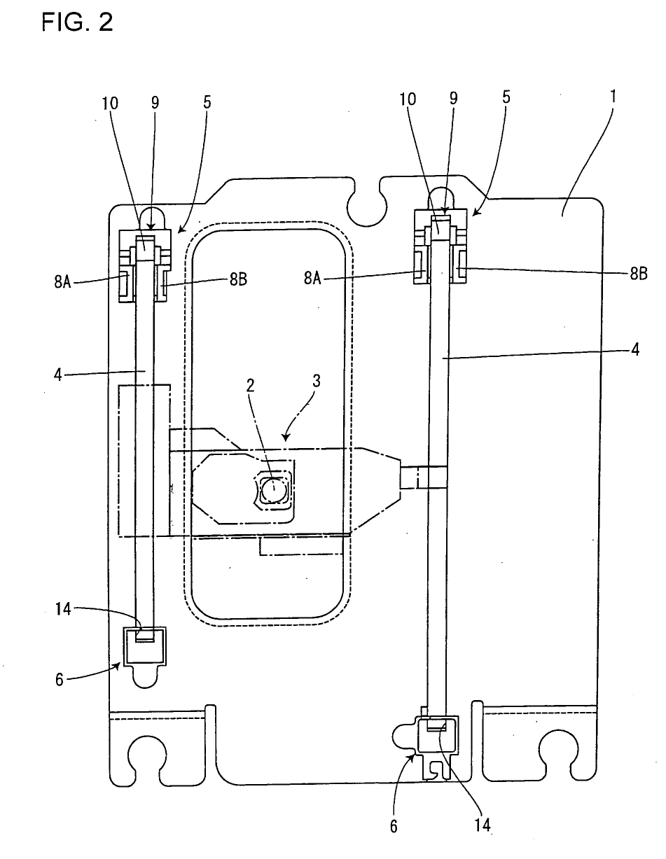

FIGS. 1 to 5 show an embodiment of the present invention and in these figures, reference number 1 denotes a chassis formed by bending a metal sheet and a pair of right and left guide shafts 4 for guiding a pickup 3 provided with a pickup lens 2 built in the chassis 1. To hold both ends of these guide shafts 4, a pair of holding members 5, 6 made of synthetic resin are fixed to the chassis 1 as parts integral therewith, and one holding member 5 is constructed of a base 7, a pair of right and left guide walls 8A, 8B disposed upright on both sides of this base 7 facing each other, a stopper section 9 having flexibility disposed upright at a back end of the base 7 and a hook-like hooking section 10 provided with a tapered inclined plane 10A formed at one end of this stopper section 9 as a part integral therewith. The other holding member 6 is intended to simply position one end of the guide shaft 4 and includes an engagement groove 14 for holding the one end of the guide shaft 4, though detailed explanations are omitted here.

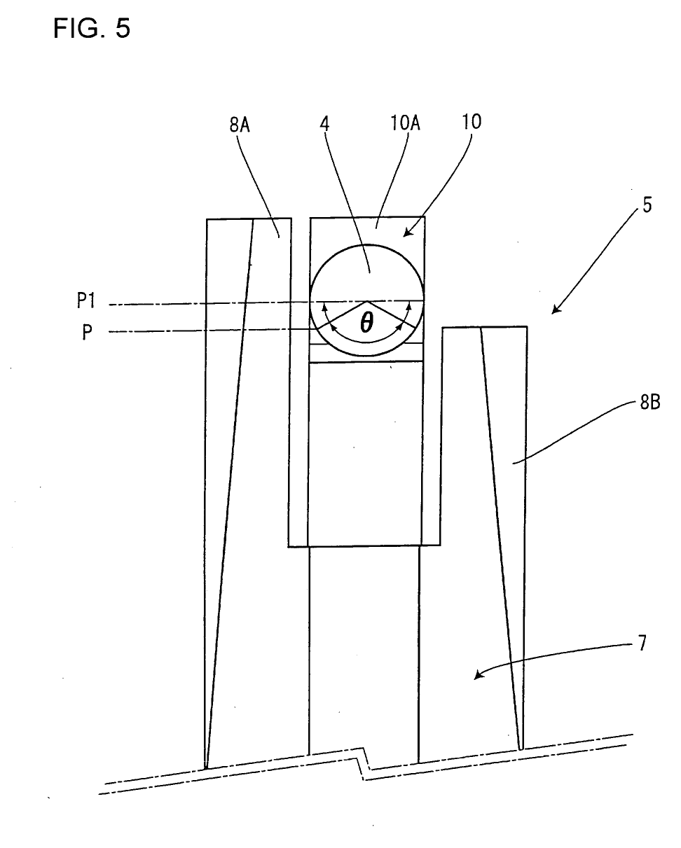

The distance between the guide walls 8A, 8B between which the end of the guide shaft 4 is inserted is set slightly wider than the diameter of the guide shaft 4 and positioning projections 11, 11 for sandwiching the guide shaft 4 are formed facing each other as parts integral with the guide walls 8A, 8B at the front end of the inner surface thereof and the distance between these projections 11, 11 substantially corresponds to the diameter of the guide shaft 4. Furthermore, the guide walls 8A, 8B have different heights and one guide wall 8A is formed to be higher than the other guide wall 8B and these guide walls 8A, 8B are formed to be higher than a bottom end 10B of the inclined plane 10A of the hooking section 10 and more specifically, as shown in FIG. 5, the lower guide wall 8B is set to substantially the same height as that of contacts P on the circumference of the circle of the guide shaft 4 whose central angle θ is 120 degrees in the direction in which the guide shaft 4 is inserted when the guide shaft 4 reaches the bottom end 10B of the hooking section 10, while the higher guide wall 8A is set to be higher than contacts P1 whose central angle θ is 180 degrees. That is, the hooking section 10 consists of a tapered inclined plane 10A and since the thrust of stopper 9 acts on the guide shaft 4 most strongly when the guide shaft 4 reaches the bottom end 10B thereof, it is preferable that the guide shaft 4 is stable in this condition. Therefore, if the lower guide wall 8B is set to substantially the same height as that of contacts P on the circumference of the circle of the guide shaft 4 whose central angle θ is 120 degrees when the guide shaft 4 reaches the bottom end 10B of the hooking section 10, approximately ⅓ of the lower part of the guide shaft 4 is hooked on to the guide wall 8B, and therefore the guide wall 8B can prevent fluctuations of the guide shaft 4 from side to side, that is, prevent the guide shaft 4 from coming off the hooking section 10. Here, to reliably prevent the guide shaft 4 from coming off, it is desirable to set the height of the guide wall 8B to the diameter of the guide shaft 4 where the thickness of the guide shaft 4 reaches a maximum when the guide shaft 4 reaches the bottom end 10B of the hooking section 10, that is, the same height as that of contacts P1 on the circumference of the circle of the guide shaft 4 whose central angle θ is 180 degrees. Furthermore, for the guide wall 8A which is set to be higher than the contacts P1, the guide shaft 4 never comes off the hooking section 10 when the hooking section 10 is engaged with the guide shaft 4. The chassis 1 is provided with an adjustment screw 15 serving as a supporting section of the guide shaft 4, which penetrates the base 7 and is screwed into the base 7 and the guide shaft 4 is placed on one end of the adjustment screw 15. After this guide shaft 4 is set, a coil spring (not shown) is connected to the guide shaft 4 and this coil spring pushes the guide shaft 4 held by the holding member 5 against the adjustment screw 15.

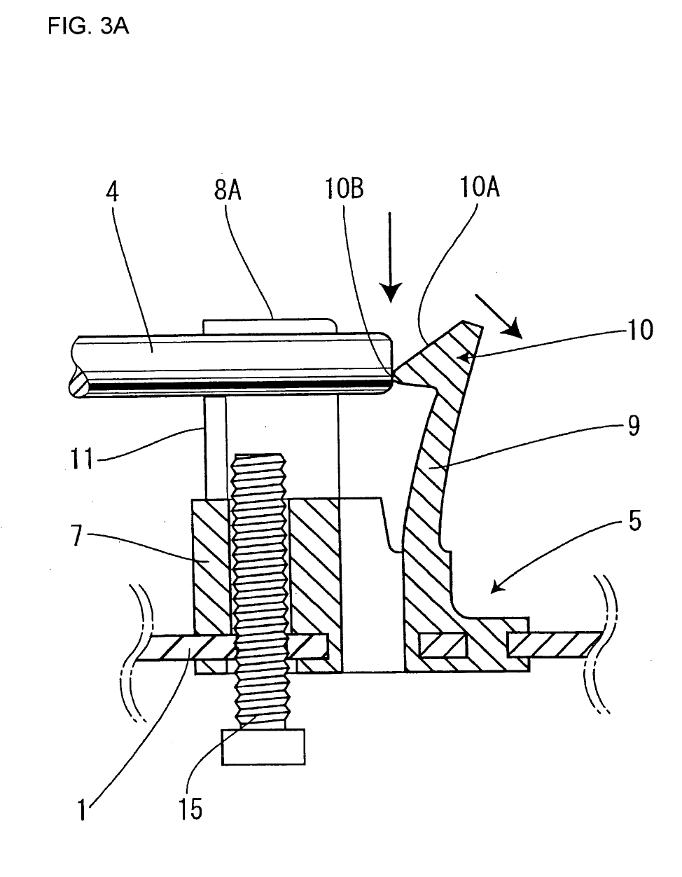

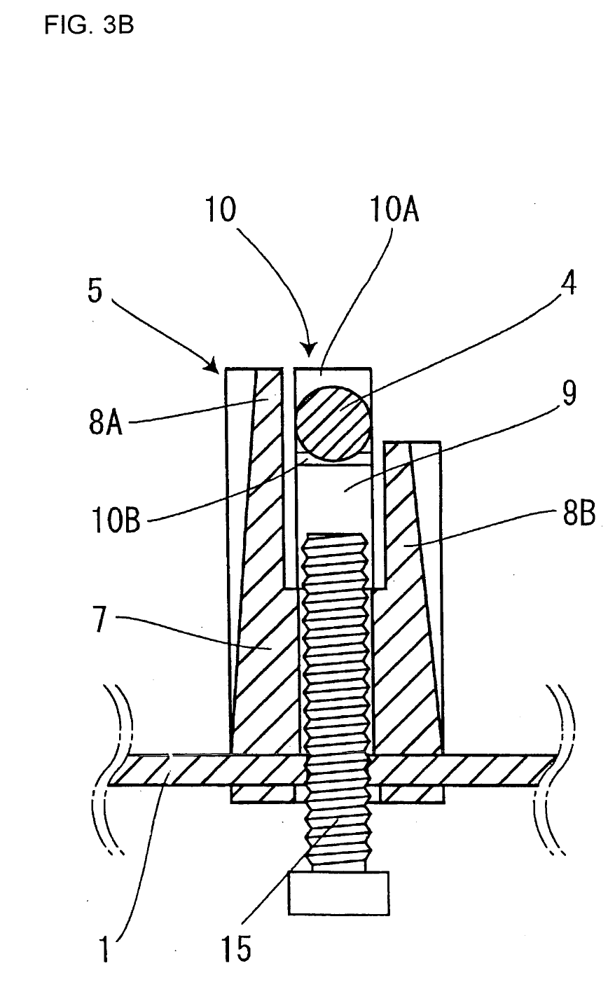

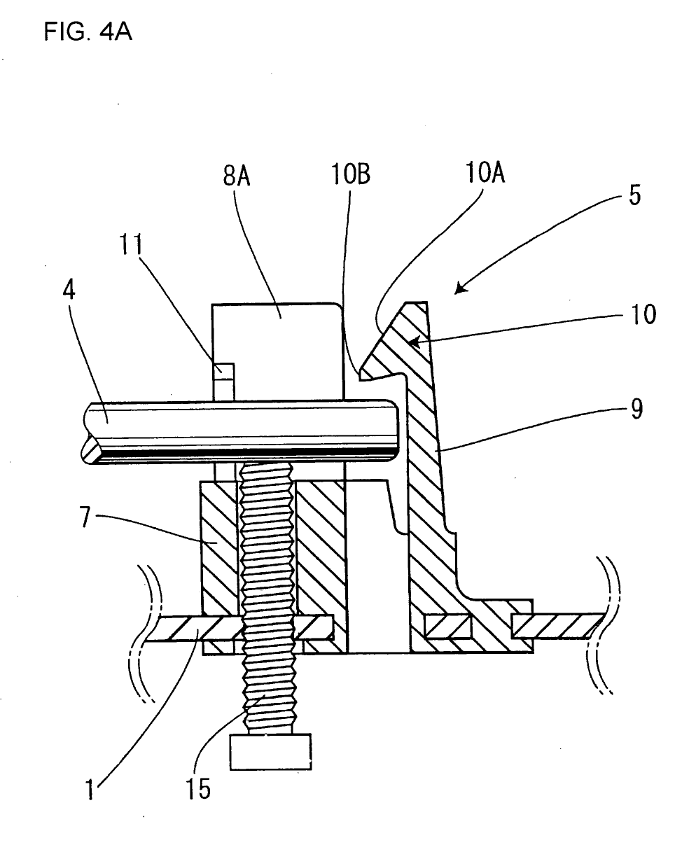

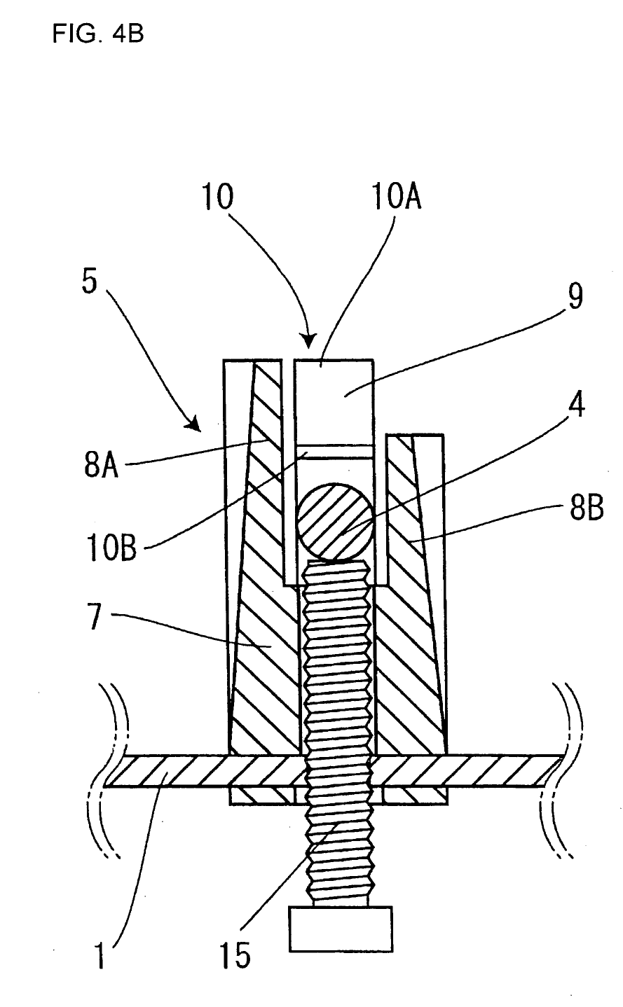

Next, the assembly procedure for the guide shaft 4 will be explained. First, with one end of the guide shaft 4 inserted into the engagement groove 14 of the holding member 6, the other end of the guide shaft 4 is brought into contact with the hooking section 10 of the stopper section 9 and the guide shaft 4 is pushed in between the guide walls 8A, 8B. When this guide shaft 4 is engaged with the hooking section 10, one guide wall 8A is set to be higher than contacts P1 on the circumference of the circle whose central angle θ is 180 degrees in the direction in which the guide shaft 4 is inserted, and it is possible to move the guide shaft 4 downward to bring the outer surface of the guide shaft 4 into contact with the hooking section 10 with the outer surface of the guide shaft 4 pushed against the guide wall 8A before the guide shaft 4 is engaged with the hooking section 10 of the stopper section 9. Therefore, the guide shaft 4 can contact the hooking section 10 with the guide shaft 4 being guided along the guide wall 8A. Thus, the guide shaft 4 can be engaged with the hooking section 10 with the guide shaft 4 being stably guided by the guide wall 8A, and at the bottom end of the hooking section 10 where the thrust of the hooking section 10 is applied most strongly to the guide shaft 4, the guide shaft 4 is sandwiched between the guide wall 8B set to substantially the same height as that of contacts P whose central angle θ is 120 degrees and the guide wall 8A which is higher than contacts P and approximately ⅓ of the lower part of the guide shaft 4 is hooked on to the guide wall 8B, and therefore these guide walls 8A, 8B can reliably prevent fluctuations of the guide shaft 4 from side to side. Thus, by pushing in the guide shaft 4 downward by being stably guided by the guide walls 8A, 8B, as shown in FIG. 3A, the hooking section 10 is pushed and the stopper section 9 is bent outward and when the guide shaft 4 climbs over the hooking section 10, the stopper section 9 is restored by an elastic restoring force of the stopper section 9 as shown in FIG. 4A. In this way, the guide shaft 4 is sandwiched between the positioning projections 11 formed on the inner surfaces of the right and left guide walls 8A, 8B whereby the movement thereof in the radial direction is regulated and the movement of the guide shaft 4 in the vertical direction is regulated by the restored hooking section 10 and the adjustment screw 15. After the guide shaft 4 is set in the chassis 1 in this way, a coil spring (not shown) is connected between the guide shaft 4 and chassis 1 and this coil spring pushes the guide shaft 4 against the adjustment screw 15. In this way, in the assembly line and the like of the disk device, after the assembly of the turn table, pickup 3, and the like is completed, it is possible to adjust the distance (height) and inclination of the guide shaft 4 with respect to the disk using the adjustment screw 15 so that the angle of the laser light agrees with a specified value.

As shown above, when the guide shaft 4 is fixed to the chassis 1, this embodiment allows the guide shaft 4 to be fixed through quite a simple operation of pushing one end of the guide shaft 4 against the hooking section 10 and also does not require parts such as fixing screws, and can thereby reduce the number of parts. Furthermore, when the guide shaft 4 is engaged with the hook 10, it is possible to push the guide shaft 4 against the hook 10 with the guide shaft 4 being guided along the guide wall 8A which is formed to be higher than the hook 10 and at the bottom end of the hooking section 10 where the thrust of the hooking section 10 is applied most strongly to the guide shaft 4, the guide shaft 4 is sandwiched between the guide wall 8B set to substantially the same height as that of contacts P whose central angle θ is 120 degrees and the guide wall 8A and approximately ⅓ of the lower part of the guide shaft 4 is hooked on to the guide wall 8B, and therefore these guide walls 8A, 8B prevent the guide shaft 4 from coming off the hooking section 10 and allows the guide shaft 4 to be stably guided between the right and left guide walls 8A, 8B. Thus, by improving stability when the guide shaft 4 is engaged with the hooking section 10, it is possible to simplify the assembly work and improve work efficiency. Furthermore, by setting one guide wall 8B to a minimum necessary height, it is possible to make the holding member 5 more compact and suppress interference with other peripheral apparatuses.

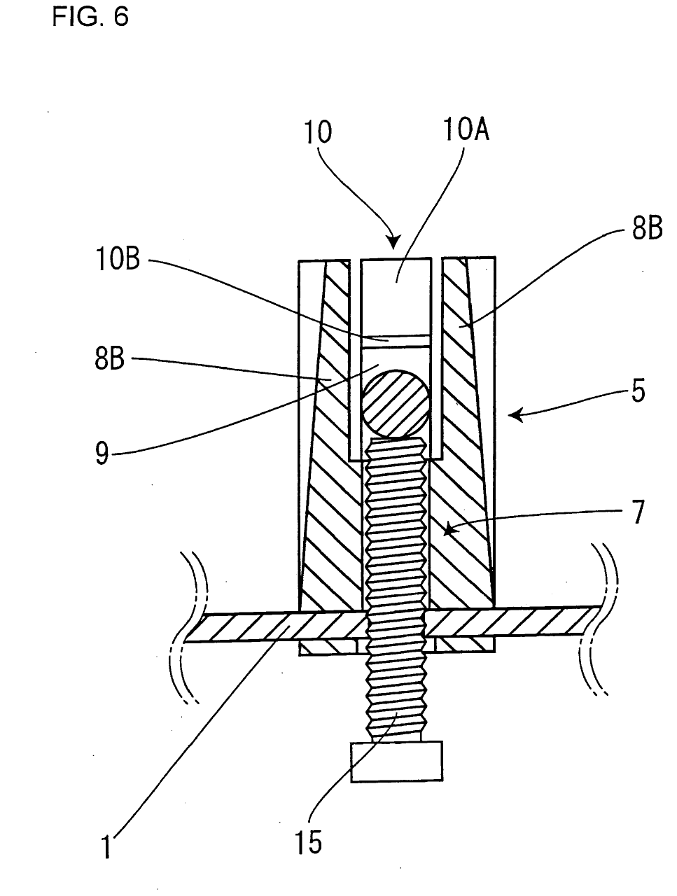

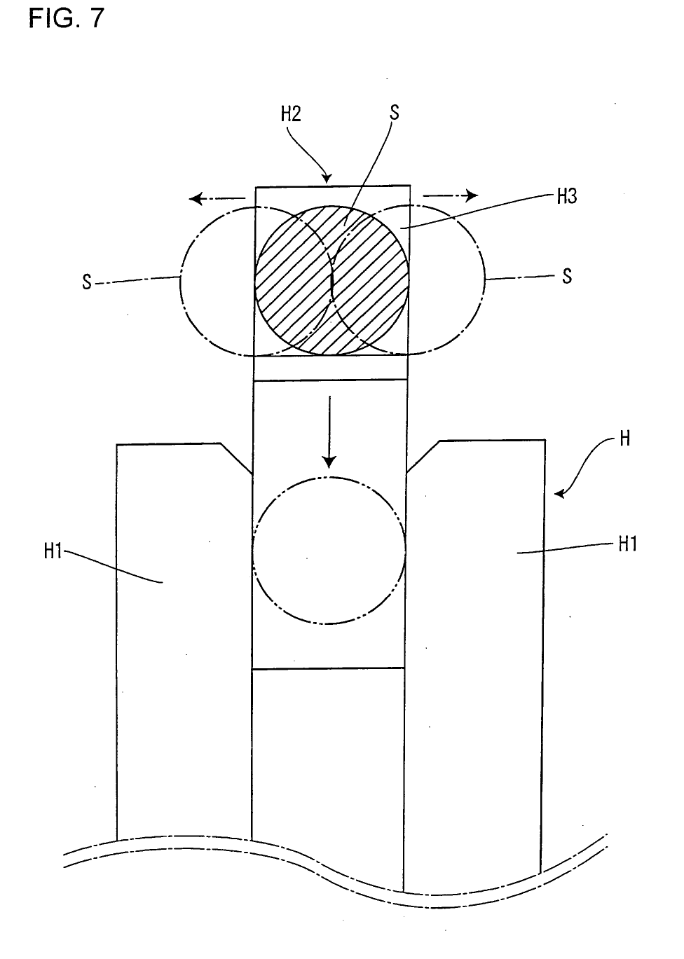

One preferred embodiment of the present invention has been explained in detail as above, however, the present invention is not limited to the above described embodiment and can be implemented modified in various ways within the scopes of the present invention. For example, the above described embodiment has shown an example where one guide wall 8B is formed to be lower than the other guide wall 8A, but it is also possible, as shown in FIG. 6, to form both guide walls 8A, 8B to be higher than the hooking section 10. Moreover, both of the guide walls 8A, 8B does not always have to be formed to be higher than the hooking section 10, and at least one of them can be formed to be higher than the hooking section 10. Furthermore, the above described embodiment has shown an example where the guide shaft 4 is inserted from above, however, it is also possible to adopt a arrangement in which the guide shaft 4 is inserted from a side direction. The basic structure such as the positional relationship among components of the holding members 5, 6 which hold the guide shaft 4 and the shape is not limited to that of the above described embodiment and can be selected as appropriate. Furthermore, the above described embodiment has explained the case where the present invention is applied to a disk device, however, the present invention is applicable to a wide variety of electronic apparatuses.

1. A guide shaft holding mechanism comprising a pair of holding members provided on a chassis, at least one of the holding members including a supporting section which supports the guide shaft, a pair of guide walls which regulate the movement of the guide shaft in a radial direction, a stopper section having flexibility which regulates the movement of the guide shaft in a thrust direction, and a hooking section which is formed in the stopper section, in which the guide shaft is engaged with the hooking section when the guide shaft is inserted between the guide walls and the hooking section and the supporting section regulates the movement of the guide shaft in the vertical direction,
wherein at least one guide wall is formed to be higher than the hooking section so that the guide shaft and the guide wall can contact each other when the guide shaft is engaged with the hooking section.

2. The guide shaft holding mechanism according to claim 1, wherein the hooking section has a tapered inclined plane capable of contacting an end face of the guide shaft and at least one guide wall is formed to be higher than the bottom end of the inclined plane.

3. The guide shaft holding mechanism according to claim 1, wherein when the guide shaft is engaged with the hooking section, at least one guide wall is set to be higher than contacts on the circumference of the circle of the guide shaft whose central angle is 120 degrees at least in the direction in which the guide shaft is inserted, or preferably set to be higher than contacts on the circumference of the circle of the guide shaft whose central angle is 180 degrees.

4. A disk device provided with the guide shaft holding mechanism according to claim 1, comprising a pickup which stores information in a storage medium or reproduces information from the storage medium, wherein the pickup is guided so as to translate through the guide shaft.

5. The guide shaft holding mechanism according to claim 2, wherein when the guide shaft is engaged with the hooking section, at least one guide wall is set to be higher than contacts on the circumference of the circle of the guide shaft whose central angle is 120 degrees at least in the direction in which the guide shaft is inserted, or preferably set to be higher than contacts on the circumference of the circle of the guide shaft whose central angle is 180 degrees.

6. A disk device provided with the guide shaft holding mechanism according to claim 2, comprising a pickup which stores information in a storage medium or reproduces information from the storage medium, wherein the pickup is guided so as to translate through the guide shaft.
